(19) United States
(12) Patent Application Publication
(10) Pub. No.: US 2024/0403100 A1
(43) Pub. Date: Dec. 5, 2024

(54) UNIFYING AND CONNECTING MULTIPLE VIRTUAL DESKTOPS

(71) Applicant: Omnissa, LLC, Mountain View, CA (US)

(72) Inventor: Lin Lv, Beijing (CN)

(21) Appl. No.: 18/326,226

(22) Filed: May 31, 2023

(51) Int. Cl. G06F 9/455; G06F 9/54; H04L 67/141

(52) U.S. Cl. CPC G06F 9/45558; G06F 9/543; H04L 67/141; G06F 2009/45595

(57) ABSTRACT

Systems and methods are described for unifying and connecting multiple virtual desktops accessed by a user on a client device to improve efficiency and user experience when the user is working on the multiple desktops. When the client device is accessing multiple virtual desktops, a connection can be established between the virtual desktops for enabling various features unifying the multiple desktops. For example, an application running on a first desktop can be redirected to a second desktop so that the user can interact with applications running in different desktops from within one desktop. Clipboards can be shared between the remote desktops to allow the user to copy data from one desktop and paste it into a different desktop. Files on each connected remote desktop can be redirected to other connected remote desktops so the user can access files of any connected remote desktop from within any other connected remote desktop.

### TECHNICAL FIELD

The present disclosure generally relates to virtual desktop infrastructure and more specifically to techniques for accessing multiple virtual desktops from one client device.

### BACKGROUND OF THE INVENTION

Virtual desktops provided as part of a virtual desktop infrastructure (VDI) or desktop-as-a-service (DAAS) offerings are becoming more commonplace in today's enterprise work environments. The security of having a remotely stored desktop, ability to access the desktop from any location and on any device, centralized desktop management, efficient use of hardware resources, as well as numerous other benefits made possible by VDI/DAAS are a large benefit for many organizations.

In a conventional VDI or DAAS environment, each user in an enterprise is provisioned a virtual desktop and is allowed to access his or her virtual desktop over a remote network connection, such as a WAN connection. The virtual desktops are typically hosted on servers that reside in a data center of the enterprise or a third-party service provider, and each host server may execute multiple virtual desktops. Users can utilize a client device to remotely log into their individual virtual desktop and all of the application execution takes place on the remote host server which is linked to the local client device over a network using a remote display protocol, such as Remote Desktop Protocol (RDP), PC-over-IP protocol (PCoIP), virtual network computing (VNC) protocol, or the like. Using the remote display protocol, the user can interact with applications of the virtual desktop, which are running on the remote host server, with only the display, keyboard, and mouse information communicated with the local client device. A common implementation of this approach is to host multiple desktop operating system instances on separate virtual machines deployed on a server hardware platform running a hypervisor.

As remote computing has become more and more mainstream, users today often access multiple remote desktops at the same time while performing their work. For example, a user may need to access different remote desktops because each desktop may have different applications, different operating systems, different computing resource configurations, etc. To work on multiple remote desktops, a user would normally connect to each remote desktop from the user's client device so they can perform different tasks on the different remote desktops from the client device. For example, the user may do video-related work on remote desktop A that is configured with a powerful CPU and GPU, do text editing-related jobs on remote desktop B that has document editing software installed, etc.

Using multiple remote desktops presents several difficulties. For example, to work on applications in different remote desktops, the user may need to constantly switch between the desktops, which can be inconvenient. Further, different remote desktops may not share files and clipboards. Accordingly, a user working on remote desktop A would not be able to open a file located on remote desktop B or share clipboards between the remote desktops to copy data (e.g., text, image, file, folder, etc.) from one remote desktop to the other remote desktop. Further, connecting to multiple remote desktops generally incurs high data transfer costs (especially in the case of graphical data and file transfers) because data is transferred between the local device and each of the multiple connected remote desktops, which can consume substantial network bandwidth and hardware resources, particularly when the remote desktops are deployed on a public cloud.

What is needed is a more efficient way for unifying and connecting multiple virtual desktops accessed by a user on a client device.

### BRIEF DESCRIPTION OF DRAWINGS

FIG. 1 illustrates an example of a virtual desktop environment, in accordance with various embodiments.

FIG. 2 illustrates an example architecture of a system for unifying and connecting multiple virtual desktops, in accordance with various embodiments.

FIG. 3 illustrates an example of a virtual desktop GUI with a local application and a redirected application, in accordance with various embodiments.

FIG. 4 illustrates an example of components in a system for unifying and connecting multiple virtual desktops, in accordance with various embodiments.

FIG. 5A illustrates part 1 of an example swim lane diagram of a process for unifying and connecting multiple virtual desktops, in accordance with various embodiments.

FIG. 5B illustrates part 2 of an example swim lane diagram of a process for unifying and connecting multiple virtual desktops, in accordance with various embodiments.

FIG. 6 illustrates an example of some general components of a computing device, in accordance with various embodiments.

### DETAILED DESCRIPTION OF THE INVENTION

Systems and methods in accordance with various embodiments of the present disclosure overcome at least some of the above-mentioned shortcomings and deficiencies by providing ways for unifying and connecting multiple virtual desktops accessed by a user on a client device to improve efficiency and user experience when the user is working on the multiple desktops. In particular, embodiments described herein leverage a mechanism for detecting when a client device is connected to multiple virtual desktops and coordinating a connection between the virtual desktops that can be used for enabling various features unifying the desktops.

Using the connection between the multiple virtual desktops, for example, an application running in a first virtual desktop can be redirected to a second virtual desktop so that the user can interact with the application running in the first virtual desktop (e.g., see the application interface and produce inputs) from within the second virtual desktop, thereby giving the user the illusion that the application is running in the second virtual desktop while it is actually running in the first virtual desktop. Accordingly, the user can use apps running in different virtual desktops from within one desktop, reducing the inconvenience of switching from one desktop to another to use both apps.

Also, using the connection between the remote desktops, clipboards can be shared or redirected between the desktops. This way, the user can copy data (e.g., text, images, files, folders, etc.) from one connected desktop and pasted it into a different connected desktops using copy/paste commands, shortcut keys (e.g., Ctrl+C and Ctrl+V), drag and drop, etc. The copied data can be transferred over the channel connecting the desktops to perform the operation.

Using the connection between the remote desktops, files and folders (e.g., the “Documents” folder) on each connected remote desktop can be redirected to other connected remote desktops so that the user can open and access files and folders of any of the connected remote desktops from within any other connected remote desktop.

For example, when an app is redirected from a first virtual desktop to a second virtual desktop, as described above, the app can access files on the second desktop to which it has been redirected using file redirection, even though the app is running in the first desktop. Further, with clipboard redirection the user can copy content from an app running locally and paste it into the redirected app, and vice versa, such as by dragging and dropping items from a window of a local app into a window of the redirected app.

As a result, when a user is working on multiple remote desktops, the frequency with which the user needs to switch between the remote desktops can be reduced and the transfer of data between the desktops for tasks such as copy/paste and file access can be performed efficiently, producing an improved user experience, improving efficiency, and reducing the amount of data transfer between the local and the remote devices, which can save significant expenses of network bandwidth and hardware resources, particularly in the case where remote desktops are based on a public cloud.

As used throughout this disclosure in the context of remote desktop environments, the terms, “desktop”, “remote desktop”, and “virtual desktop” are used interchangeably and refer to an instance of an operating system and/or applications that run(s) remotely with respect to the user. In a conventional VDI or DAAS environment, each virtual desktop corresponds to a virtual machine (VM) executed on a host server (i.e., a host computing device) that is physically located in a remote datacenter. Each host server may host any number of virtual machines (e.g., tens, hundreds, etc.) and each virtual machine may be owned by an individual user. The virtual machine typically includes a guest operating system (e.g., Windows) capable of executing applications for the user and the virtual machine is used to provide a virtual desktop for the individual user. The user who owns the virtual desktop can remotely log into his or her virtual desktop using a client device that establishes a network connection (e.g., Wide Area Network connection) with the host server and remotely execute various applications on the virtual machine as if the desktop was running on the user's local client device. The client device can be any computing device capable of establishing a network connection, including but not limited to personal computers (PCs), laptops, mobile phones, tablet computers, wearable devices (e.g., smart watches, electronic smart glasses, etc.) or the like.

When a client device is accessing a remote desktop using a remote display protocol (e.g., RDP, PCOIP, VNC, etc.), the graphical user interface (GUI) of the desktop is generated on the server, the GUI image data is then encoded and transmitted over the network to the client device, where it is decoded and displayed to the user. For example, in one embodiment, the framebuffer pixel data on the server is encoded using a codec, such as H264, and transmitted over an Internet connection to the client, where the data is decoded and rendered on a local display screen to the user. Similarly, any user input information, such as keyboard and mouse events, is transmitted from the client device to the server over the network connection, where it may in turn cause various updates to the GUI of the remote desktop. In this manner, the user is able to view the GUI of the remote desktop and interact with it as if the desktop was actually running on the local client device, even though the desktop is actually executing remotely.

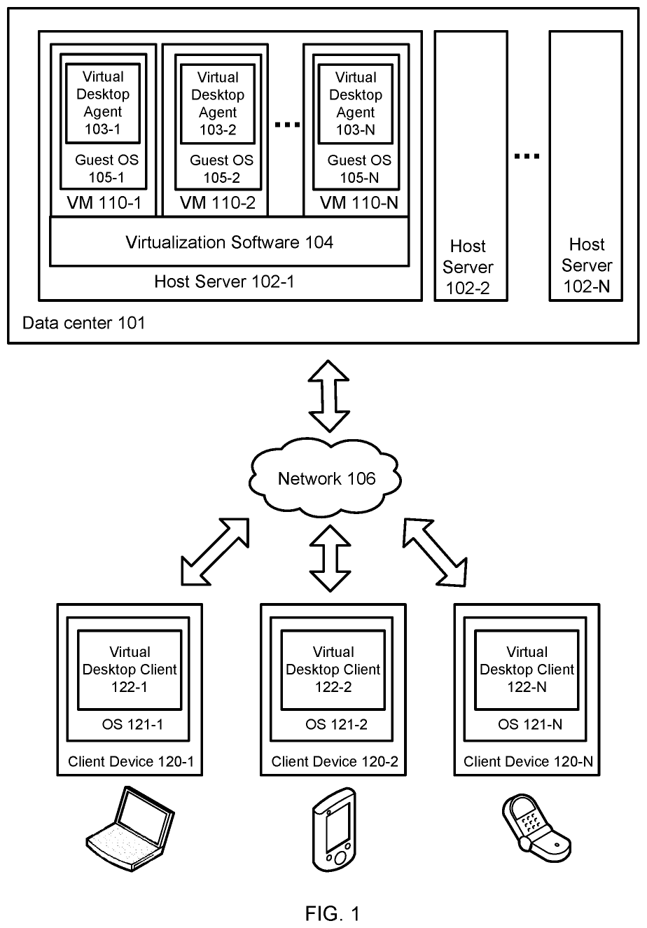

FIG. 1 illustrates an example of a virtual desktop environment, in accordance with various embodiments. The virtual desktop environment, such as VDI or DAAS environment, includes host servers (102-1, 102-2, 102-N) that are communicatively coupled with a number of client devices (120-1, 120-2, 120-N) via a network 106. Network 106 may be a wide area network (WAN), or other form of remote communication link between the host servers (102-1, 102-2, 102-N) and client devices (120-1, 120-2, 120-N). Network 106 may further include numerous other components, such as one or more firewalls, connection brokers, management servers, etc., which are not shown here so as not to obscure salient features of the remote desktop environment. Host servers (102-1, 102-2, 102-N) may physically reside in a data center 101 of the enterprise (e.g., in case of VDI) or in a data center of a third-party service provider (e.g., in case of DAAS).

By way of illustration, host server 102-1 can interoperate with client devices (120-1, 120-2, 120-N) to provide virtual desktop services to users of client devices (120-1, 120-2, 120-N). For example, host server 102-1 can host, for each user, a desktop that is presented by a guest operating system (such as one of the guest operating systems 105-1, 105-2, 105-N) running on a virtual machine (such as one of the virtual machines 110-1, 110-2, 110-N) on host server 102-1. In this context, the terms “desktop”, “remote desktop”, and “virtual desktop” refer to a computing environment in which a user can launch, interact with, and manage the user's applications, settings, and data. Each client device (120-1, 120-2, 120-N) can allow a user to view on a desktop graphical user interface (on a local display device) his/her desktop that is running remotely on host server 102-1, as well as provide commands for controlling the desktop. In this manner, the users of client devices (e.g., 120-1, 120-2, 120-N) can interact with the desktops hosted on host server 102-1 as if the desktops were executing locally on client devices (120-1, 120-2, 120-N).

In the embodiment of FIG. 1, host server 102-1 includes virtualization software 104 that supports the execution of one or more virtual machines (VMs) (e.g., 110-1, 110-2, 110-N). The virtualization software 104 may be a hypervisor, a virtual machine manager (VMM) or other software that allows multiple virtual machines to share the physical resources of the server. In the illustrated embodiment, each virtual machine (e.g., 110-1, 110-2, 110-N) can execute a guest operating system (e.g., 105-1, 105-2, 105-N) that hosts a desktop for a single user at a time. For example, if five users connect to host server 102-1 for the purpose of initiating remote desktop sessions, the host server 102-1 can launch five VMs, each hosting one desktop for each one of the five users. These types of virtual desktop environments where user desktops are hosted within separate, server-side virtual machines are often referred to as virtual desktop infrastructure (VDI) or Desktop-as-a-Service (DAAS) environments.

In such virtual desktop environments, each client device (e.g., 120-1, 120-2, 120-N) can execute a virtual desktop client (e.g., 122-1, 122-2, 122-N). For example, the virtual desktop client (e.g., 122-1, 122-2, 122-N) can be a stand-alone, designated client application (“native client”), or a web browser (“web client”). In some cases, a standard web browser may be modified with a plugin to operate as a web client. The interaction between the virtual desktop and the client device can be facilitated by such a virtual desktop client (e.g., 122-1, 122-2, 122-N) running in the OS (e.g., 121-1, 121-2, 121-N) on the client device (e.g., 120-1, 120-2, 120-N) which communicates with a server-side virtual desktop agent (e.g., 103-1, 103-2, 103-N) that is running on the guest OS inside the virtual machine (e.g., 110-1, 110-2, 110-N). In particular, the interaction can be performed by the virtual desktop agent transmitting encoded visual display information (e.g., framebuffer data) over the network to the virtual desktop client and the virtual desktop client in turn transmitting user input events (e.g., keyboard, mouse events) to the remote desktop agent.

It should be noted that the particular virtual desktop environment illustrated in FIG. 1 is shown purely for purposes of illustration and is not intended to be in any way inclusive or limiting to the embodiments that are described herein. For example, a typical enterprise VDI deployment would include many more host servers, which may be distributed over multiple data centers, which might include many other types of devices, such as switches, power supplies, cooling systems, environmental controls, and the like, which are not illustrated herein. Similarly, a single host server would typically host many more virtual machines than what is shown in this illustration. It will be apparent to one of ordinary skill in the art that the example shown in FIG. 1, as well as all other figures in this disclosure have been simplified for ease of understanding and are not intended to be exhaustive or limiting to the scope of the invention.

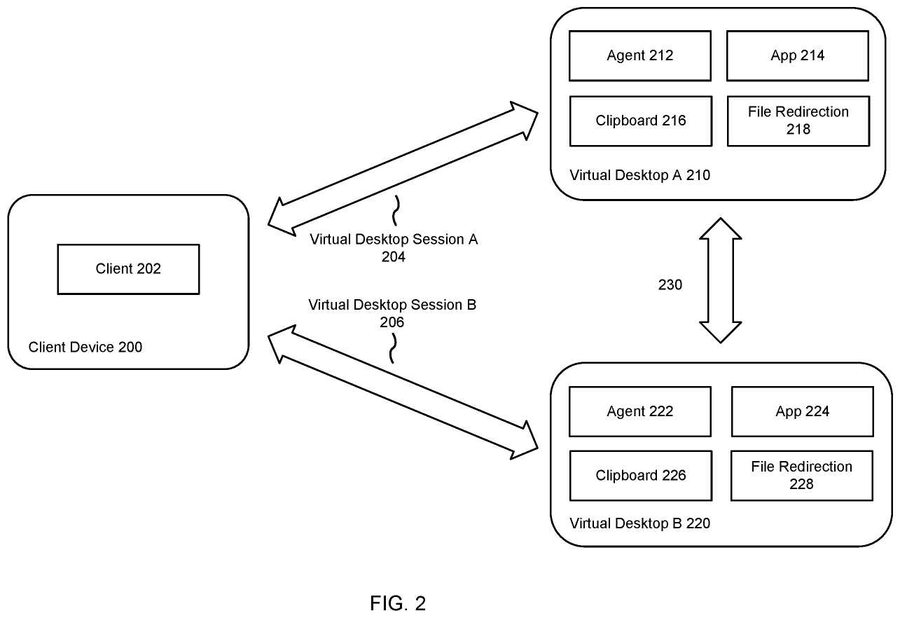

FIG. 2 illustrates an example architecture of a system for unifying and connecting multiple virtual desktops, in accordance with various embodiments. As illustrated in the example of FIG. 2, a client device 200 can connect to two virtual desktops, virtual desktop A 210 and virtual desktop B 220, to access the virtual desktops. In various embodiments, the client device 200 can be a user device such as a laptop, desktop computer, tablet, smartphone, and so on. Virtual desktops A 210 and B 220 can each operate on the same or a different server and connect to the client device 200 over a network connection.

A client 202 (e.g., a virtual desktop client) running on the client device 200 can connect to an agent 212 (e.g., a virtual desktop agent) running in virtual desktop A 210 and establish virtual desktop session A 204, in which a user of the client device 200 can access and interact with virtual desktop A 210. For example, user inputs into desktop A 210 can be sent by the client 202 to the agent 212 to be effectuated in virtual desktop A 210, and the virtual desktop A 210 GUI can be transmitted by the agent 212 to the client 202 to be displayed in a client 202 window on the client device 200. Similarly, the client 202 on the client device 200 can connect to an agent 222 (e.g., a virtual desktop agent) running in virtual desktop B 220 and establish virtual desktop session B 206, in which the user of the client device 200 can interact with virtual desktop B 220. User inputs into desktop B 220 can be sent by the client 202 to the agent 222 to be effectuated in desktop B 220, and the desktop B 220 GUI can be transmitted by the agent 222 to the client 202 to be displayed in a client 202 window on the client device 200, which can be a different window than the window of virtual desktop session A 204.

After virtual desktop session A 204 and virtual desktop session B 206 are established, the user can switch or alternate between working on virtual desktop A 210 and working on virtual desktop B 220 on the client device 200. When the user switches to working on desktop A 210, the client 202 can send the user's inputs to the desktop A agent 212, to be effectuated in desktop A 210. When the user switches to desktop B 220, the client 202 can switch to sending the user's inputs to the desktop B agent 222, to be effectuated in desktop B 220.

In various embodiments, the client 202 can interoperate with each agent 212, 222 in a similar fashion as the virtual desktop clients and virtual desktop agents described in the example of FIG. 1, except in this case a single client can correspond with multiple agents (e.g., agent 212 and agent 222), as illustrated in the example of FIG. 2.

As mentioned above, with previous technologies, when a user worked on multiple virtual desktops from their client device, as in the example of FIG. 2, various difficulties were present as the user was forced to switch between the virtual desktops to work on applications in different virtual desktops and files and clipboards were not shared by the desktops. In various embodiments, to overcome such issues, a connection 230 can be established between the virtual desktops 210, 220 over a channel via which data can be exchanged between the desktops 210, 220 to enable various features unifying the desktops.

For example, after the system detects that the client device 200 or the client 202 has connected to (or established virtual desktop sessions with) multiple virtual desktops, e.g., desktop A 210 and desktop B 220, it can coordinate the connection 230 between the desktops (e.g., the client 202 can request one of the desktops to connect to the other). In various embodiments, the channel can be a virtual channel (e.g., per a remote display protocol) connecting the virtual desktops 210, 220. The channel can connect the desktops 210, 220 over a network (WAN, LAN, etc.) or directly, depending on the location of the desktops 210, 220. By having such a connection 230 between the virtual desktops 210, 220, the system can transfer data between the desktops 210, 220 efficiently (e.g., without needing to transfer data (graphical data, file data, clipboard contents, etc.) through the client device 200).

After the connection 230 between the desktops 210, 220 is established, it can be used to enable various features unifying and connecting the desktops 210, 220.

In various embodiments, an application running on one of the desktops can be redirected to the other desktop. For example, using the connection 230 between the virtual desktops 210, 220, an application or “app” 214 running in desktop A 210 can be redirected to desktop B 220 so that the user can interact with the app 214 (e.g., see the application interface and produce inputs into the app 214) from within desktop B 220, thereby giving the user the illusion that the app 214 is running in desktop B 220 while it is actually running in desktop A 210. This way, the user may be able to use applications running in both virtual desktops 210, 220 on one desktop, without the inconvenience of needing to switch from one desktop to the other.

To redirect the app 214 from desktop A 210 to desktop B 220, for example, the graphical user interface (GUI) of the application 214 can be streamed from desktop A 210 to desktop B 220 over the connection 230 and presented in an application window in desktop B 220 so that the user can see the app 214 interface in the desktop B 220 GUI, which is streamed to the client 202 and displayed on the client device 200 during virtual desktop session B 206. More specifically, the app 214 GUI can be streamed from desktop A 210 to desktop B 220 via the channel 230 and presented in a window in the GUI of desktop B 220. Then, the GUI of desktop B 220 containing the app 214 window can be streamed to the client 202 while the user accesses virtual desktop B 220 during virtual desktop session B 206. User inputs into the app 214 can be conveyed from the client device 200 (by the client 202) to virtual desktop B 220 (e.g., to the agent 222) during virtual desktop session B 206 (e.g., in the same way as other inputs are conveyed from the client 202 to apps running in virtual desktop B 220). When virtual desktop B 220 receives the inputs targeting the app 214, it can send or forward those inputs to virtual desktop A 210 to be effectuated in the app 214. The inputs can be conveyed over the connection 230.

In various embodiments, when the app 214 is redirected to virtual desktop B 220, it can be presented as a seamless window to give the user the impression that the app 214 is running in virtual desktop B 220. “Seamless window”, as used herein, refers to an application delivery method that allows remote applications to appear like local applications, giving users the illusion that the remote app is actually running locally. For example, when the app 214 is redirected to desktop B 220, to present it as a seamless window the guest operating system's background of desktop A 210 can be cropped, masked, or blocked leaving just the interface of the app 214 and the app 214 interface can be presented in a window in desktop B 220 GUI, which gives the appearance that the app 214 is running locally on desktop B 220.

In the same way, using the connection 230 between the virtual desktops 210, 220, an app 224 running in desktop B 220 can be redirected to desktop A 210 so that the user can interact with the app 224 (e.g., see the app interface and produce inputs into the app 224) from within desktop A 210, thereby giving the user the illusion that the app 224 is running in desktop A 210 while it is actually running in desktop A 210.

In various embodiments, when it is detected that the client device 200 (or the client 202) has connected to the multiple desktops, e.g., to desktops A 210 and B 220, the system can automatically redirect apps from each desktop to the other desktop. In various embodiments, the system can redirect the topmost app from desktop A 210 to desktop B 220, and the topmost app from desktop B 220 to desktop A 210. For example, when the user switches from desktop A 210 to desktop B 220, the system can automatically redirect the topmost app from desktop A 210 to desktop B 220. When the user switches back to desktop A 210 from desktop B 220, the system can automatically redirect the topmost app from desktop B 220 to desktop A 210.

The “topmost app” can mean the app that is active in the desktop, the app with focus of the operating system (OS), or the app whose window is on top of other app windows on that remote desktop. Thus, the topmost app running in desktop A 210, can be redirected to desktop B 220 and presented in the GUI of desktop B 220 (e.g., as a seamless application). Similarly, the topmost app running in desktop B 220, can be redirected to desktop A 210 and presented in the GUI of desktop A 210 (e.g., as a seamless application). This way, when the user switches from one desktop to the other, they will be able to see and work on the topmost app from the other desktop in the current desktop.

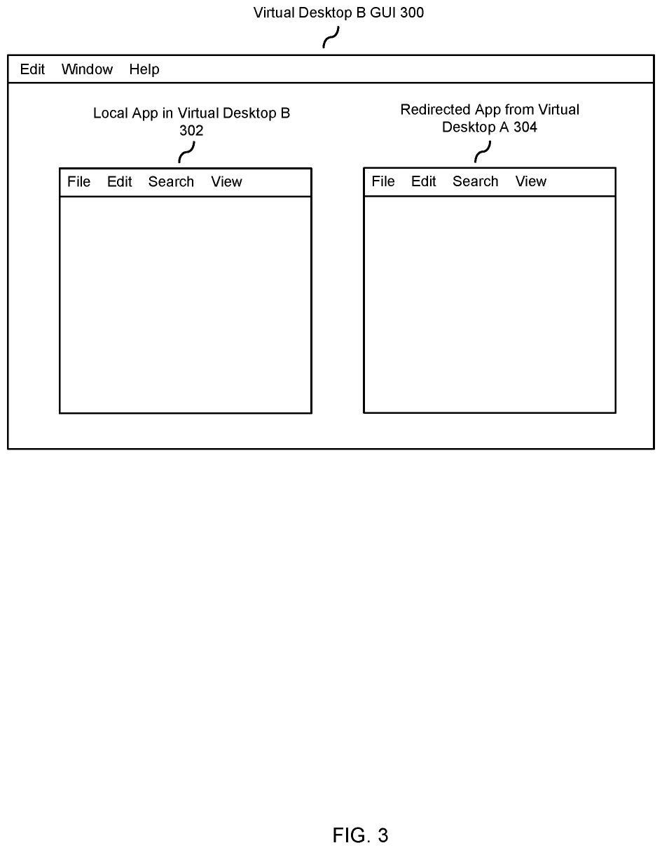

FIG. 3 illustrates an example of a virtual desktop GUI with a local application and a redirected application, in accordance with various embodiments. As illustrated, a virtual desktop B GUI 300, which can correspond to the GUI of virtual desktop B 220 that is streamed to the client 202 in the example of FIG. 2 and presented in a client 202 window on the client device 200 to the user, can contain two application windows 302, 304. The GUI 300 can contain a local app window 302, which can be a window produced by an application installed on the OS of virtual desktop B. The GUI 300 can further contain a window 304 of an application running in desktop A, which is redirected from virtual desktop A to desktop B (e.g., such as app 214 in the example of FIG. 2). The redirected app window 304 can be a seamless window that appears and behaves like a window of a local app on desktop B, while the application is actually installed and running on virtual desktop A.

When the user makes inputs in virtual desktop B into the redirected app 304 (e.g. when the redirected app window 304 is active, in focus, etc.), such as by clicking in the window 304, making mouse or keyboards inputs into the window 304, etc.) those inputs can be sent to virtual desktop B via the virtual desktop session on virtual desktop B, and virtual desktop B can then forward the inputs to virtual desktop A (e.g., via an established channel connecting the desktops such as the channel 230 in the example of FIG. 2) to be effectuated in the application on desktop A.

In various embodiments, if while working in the desktop B GUI 300 the user closes the redirected app A 304 window, the app running in desktop A (e.g., app 214) can be accordingly closed in desktop A and a new app that subsequently becomes the topmost app in desktop A can be redirected to desktop B instead and displayed in the same way in the desktop B GUI 300. If no more apps are open in desktop A, then the window 304 can simply be closed.

Returning to the example of FIG. 2, in the same way that the app 214 running in virtual desktop A 210 can be redirected to virtual desktop B 220, an app 224 running in virtual desktop B 220 can be redirected to virtual desktop A 210. For example, when the user switches to desktop A 210.

In a similar fashion, if a user connects to more than two desktops, the apps can be redirected from each desktop to the other desktops. For example, if the user connects to three remote desktops, A, B and C, the topmost app on remote desktop B and C can be redirected to remote desktop A and displayed (e.g., as a seamless window) when the user is using remote desktop A currently. If the user switches to remote desktop B, then the topmost app on remote desktop A and remote desktop C can be redirected and displayed (e.g., as a seamless window) on remote desktop B so the user can use the redirected apps with other apps on remote desktop B in a similar way as if they were native apps on remote desktop B. Similarly, clipboards can be redirected between all three desktops, so that a user can copy data from an app running in either desktop and paste it into an app running in any other desktops. Files can also be redirected, so that an application running on a desktop can access files on any of the other desktops.

In various embodiments, the connection 230 can be used to enable clipboard redirection or clipboard sharing between the remote desktops 210, 220, so that content copied from one desktop (e.g., desktop B 220) can be transferred over the connection 230 to be pasted into the other desktop (e.g., desktop A 210), and vice versa. For example, when working in desktop B 220, the user can copy data (e.g., by using shortcut keys (e.g., Ctrl+C), drag and drop actions, via a menu selection, etc.) in desktop B 220 (or in an application running in desktop B 220). Subsequently, the user can produce a paste command in desktop A 210, or in an application in desktop A 210 (e.g., by using shortcut keys (e.g., Ctrl+V), drag and drop, via a menu selection, etc.) to paste the copied content. For example, after copying the data in desktop B 220, the user can switch to desktop A 210 and perform the paste command in desktop A 210. Alternatively, the user can continue working in desktop B 220 and paste the data into the app 214 being redirected to desktop B 220 from desktop A 210. For example, returning to the example of FIG. 3, when working in the virtual desktop B GUI 300, the user can copy data from the local app window 302 and paste the data (e.g., by drag and drop, keyboard shortcuts, etc.) into the redirected app from desktop A window 304. To perform the paste operation, the copied data can be transferred over the connection 230 from desktop B 220 to desktop A 210 and be pasted into the application 214 running in desktop A 210. In the same way, the user can copy data from the redirected app from desktop A window 304 and paste it into the local app window 302.

Different approaches can be utilized for coordinating copy/paste operations between desktops. Certain logic and methods can be implemented so that when a user produces a paste command in a desktop, the system can determine what data in either connected desktop (e.g. 210, 220) was last copied and retrieve that data (which may have been copied on either desktop A 210 or desktop B 220) for pasting in response to the paste command. For example, virtual desktops A 210 and B 220 can each contain corresponding clipboards 216, 226, which can for example be standard components (e.g., in the OS of the desktop) used by applications and the OS of the remote desktop for storing copied data and retrieving data in response to paste commands.

In various embodiments, when a copy command is received on desktop A 210 or B 220, the copied data can be stored in desktop A clipboard 216 or desktop B clipboard 226, respectively. To enable redirection of the clipboards 216, 226 between the desktops 210, 220, when a paste command is received on a desktop, for example on desktop A 210, if the last copy operation was produced on desktop B 220, then the corresponding copied data can be retrieved from the desktop B clipboard 226 and transferred (e.g., over the connection 230) to desktop A 210 to be pasted there. If, on the other hand, the last copy operation was made on desktop A 210, then the corresponding copied data can be retrieved from the desktop A clipboard 216 and pasted in desktop A 210 (which may be the standard copy/paste procedure of the desktop without clipboard redirection).

In an embodiment, clipboard sharing can be implemented by filtering or monitoring requests to the clipboards 216, 226. For example, because a paste request generally results in a query being made to the system clipboard 216, 226, paste requests on the virtual desktops 210, 220 can be detected by monitoring (or filtering) accesses or data requests to the clipboards 216, 226. For example, in various embodiments, a data request can be received at the desktop A clipboard 216 (e.g., by the file system) and in response the system can hang or suspend the request, determine that the last copy operation was performed on virtual desktop B 220, retrieve the copied data from the virtual desktop B clipboard 226 over the channel 230, and return the retrieved data in response to the request. The system can determine whether the last copy operation was performed on virtual desktop B or virtual desktop A in different ways. For example, the system can check both desktops' clipboards 216, 226 to determine which one contains the most recently copied data, it can maintain a universal clipboard that keeps or tracks copied data from either desktop, use a tracking mechanism for determining where the last copy operation took place, etc.

In various embodiments, the channel 230 can be used to redirect files between the remote desktops 210, 220 so that each desktop is able to access files on the other desktop using the connection 230. For example, files, folders, or drives (e.g., the user “Documents” folder) on each connected remote desktop can be redirected to the other remote desktop so that the user can access the redirected files, folders, or drives of either remote desktop on the other connected remote desktop.

For example, with file redirection, applications running in virtual desktop A 210 may be able to access files, documents, and data that are stored on virtual desktop B 220. To implement this feature, a file redirection component 218 on virtual desktop A 210 can be utilized that forwards input/output (I/O) requests from virtual desktop A 210 targeting the shared content on virtual desktop B 220 over the connection 230 to a corresponding file redirection component 228 on virtual desktop B 220.

For example, with the file redirection feature, data located on virtual desktop B 220 can be presented in a virtual drive in the virtual desktop A 210. In various embodiments, the system can be configured so that any predefined locations (e.g., directories, files, folders (e.g., the “Documents” folder), drives, etc.) on virtual desktop B 220 are redirected to virtual desktop A 210. The redirected files from desktop B 220 can be presented in a virtual drive in desktop A 210 that is mapped to the corresponding locations of the data on desktop B 220. For example, the virtual drive can be mounted in the file system of desktop A 210 and behave and appear as a normal mounted drive, while inputs and outputs to the virtual drive are redirected (by the file redirection modules 218, 228) to virtual desktop B 220, where the data actually resides. The user can work with the virtual drive in the same way they work with disk drives that are local for the desktop, and applications running in the virtual desktop A 210 can likewise access the virtual drive in the same way as local drives of desktop A 210. When an input/output (I/O) request is produced on virtual desktop A 210 (e.g., by an application in virtual desktop A 210) to the redirected files (e.g., to the mounted virtual drive) on virtual desktop B 220, the file redirection component 218 running in virtual desktop A 210 can forward the I/O request to virtual desktop B 220 over the channel 230. The corresponding file redirection component 228 on virtual desktop B 220 can receive and implement the I/O request, whether by retrieving data and sending the data back to virtual desktop A 210 (e.g., over the connection 230), by writing to a file on virtual desktop B 220, etc. as the case may be.

In the same way, data content (files, drives, folders, etc.) of virtual desktop A 210 can be redirected to virtual desktop B 220, so that the user is able to access the desktop A 210 content while working in desktop B 220, and applications running in virtual desktop B 220 are likewise able to access the redirected files located on virtual desktop A 210.

Further, when an app (e.g., an app 214 running in desktop A 210) is redirected to another desktop (e.g., desktop B 220), the app 214 can access files located on either desktop A 210, where the app 214 is running, or the app 214 can access files located on desktop B 220 via file redirection.

It should be noted that while the example of FIG. 2 illustrates only two virtual desktops connected to the client device, implementations of the invention can contain a larger number of virtual desktops connected to the client device 200. For example, if more than two desktops are connected, then a connection (such as connection 230) can be established connecting each desktop to each other desktop and the features described above can be implemented utilizing these inter-desktop connections. For example, the apps (e.g., the topmost app) from each desktop can be redirected to each of the other two or more connected desktops. Similarly, clipboards can be shared by all desktops, so that the user can copy data on any desktop and copy that data into any one of the other two or more connected desktops. Files can likewise be redirected from each desktop to each of the two or more other connected desktops, so that each desktop and apps running on the desktop is able to access the redirected content (files, folder, drives, etc.) on each of the other two or more connected desktops.

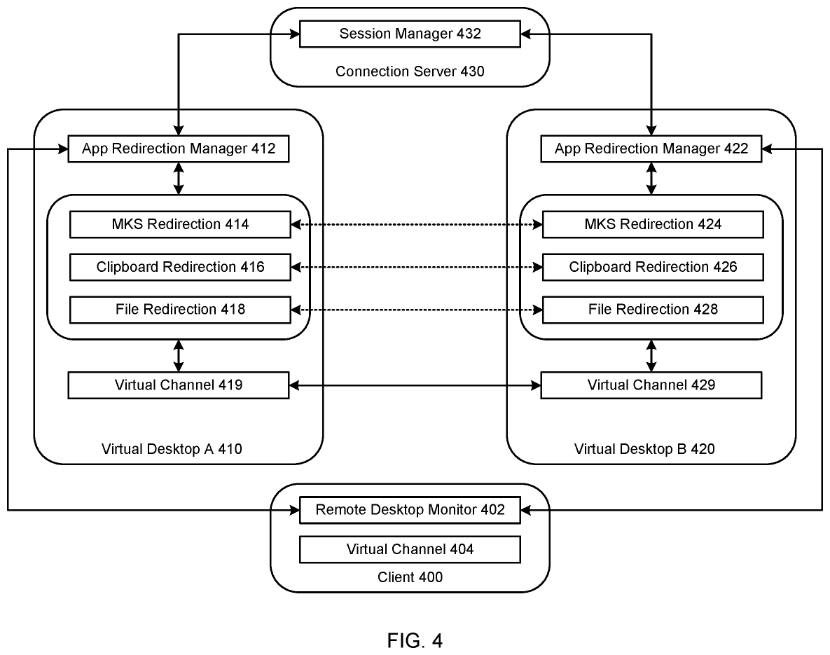

FIG. 4 illustrates an example of components in a system for unifying and connecting multiple virtual desktops, in accordance with various embodiments. The example of FIG. 4 illustrates a client 400, which can be a virtual desktop client installed on a local client device and used by a user to access virtual desktops, such as virtual desktop A 410 and virtual desktop B 420. A connection server 430 can facilitate establishing virtual desktop sessions between the client 400 and remote desktops (e.g., desktop A 410 or desktop B 420). For example, when the user requests the client 400 to connect to a remote desktop (e.g., desktop A 410), the client 400 can send a request to the connection server 430 to connect to desktop A 410. In response to the client request to connect to virtual desktop A 410, the connection server 430 can request a session token from virtual desktop A 410 and return the session token to the client 400. The client 400 can then contact virtual desktop A 410 using the session token to establish a connection and a virtual channel for transferring various data between the local device and virtual desktop A 410. In various embodiments, after the client 400 has connected to virtual desktop A 410 and virtual desktop B 420, the connection server 430 can further facilitate establishing a connection and a channel (e.g., such as the connection 230 between desktop A 210 and desktop B 220 in the example of FIG. 2) between the remote desktops 410, 420 to enable the sharing of data between the desktops 410, 420 for implementing features such as app redirection, clipboard redirection, and file redirection.

As illustrated, the connection server 430 can contain a session manager module 432 responsible for managing virtual desktop sessions and connections between virtual desktops. In various embodiments, the session manager 432 can be produced by modifying and adding functionality as applicable for performing the present invention to a standard session manager used in connection servers of previous technologies (e.g., which was responsible for authenticating clients and managing client-virtual desktop connections in previous technologies). In various embodiments, the session manager 432 can manage the authentication of the client 400 for sessions on virtual desktop A 410 and virtual desktop B 420, the establishing of the virtual desktop sessions and corresponding required connections between the client 400 and the desktops 410, 420, as wells as establishing the connection between desktop A 410 and desktop B 420 for performing app redirection, clipboard redirection, and file redirection between the desktops.

As mentioned, when the system detects that the client 400 is connected to multiple remote desktops (e.g., to virtual desktop A 410 and virtual desktop B 420), it can coordinate a connection between the desktops 410, 420. For example, when the client 400 detects that it has connected to desktop A 410 and to desktop B 420, it can request the desktops 410, 420 to connect to each other. In various embodiments, the client 400 can request the desktop that is active or is currently being used by the user to establish a connection with other remote desktops via the connection server 430. For example, if the user is currently using desktop A 410, then the client 400 can request desktop A 410 to connect to desktop B 420. Desktop A 410 can then send a request to the connection server 430 to connect to desktop B 420. The connection server 430 can first verify the validity of the connection request and then request a session token from desktop B 420 and send the session token to desktop A 410. Desktop A 410 can then communicate with desktop B 420 and establish a connection between the desktops 410, 420 using the obtained session token. The connection can then be used to enable the desktop unifying features described here (e.g., app, file, and clipboard redirection).

In various embodiments, a remote desktop monitor module 402 can execute on the client 400 to monitor remote desktop session connections. For example, the remote desktop monitor 402 can be implemented on the client 400 to monitor if the user is connecting to or disconnecting from remote desktops so that connections can be established between connected desktops and connections to desktops that are being disconnected can be destroyed. For example, if the user is connecting to multiple remote desktops, the remote desktop monitor 402 can inform the current remote desktop (the one being used by the user) to establish a connection with the other connected desktops. If the user is disconnecting from one of the remote desktops, the remote desktop monitor 402 can notify the disconnecting remote desktops to destroy the connections to the other connected remote desktops.

Virtual desktop A 410 and virtual desktop B 410 can each contain a corresponding app redirection manager 412, 422. When the client 400 connects to multiple remote desktops, for example when the client 400 connects to desktop B 420 after desktop A 410 is already connected, the app redirection manager 422 on desktop B can be notified by the remote desktop monitor 402 on the client 400 to establish a connection with other connected remote desktops (e.g., with desktop A 410). The app redirection manager 422 can first request the connection server 430 to provide session tokens from the other connected desktops (e.g., from desktop A 410) and it can then communicate with the other remote desktops (e.g., with desktop A 410) to establish a connection and virtual protocol channel between those remote desktops (e.g., desktop A 410) for data transferring. Then, the app redirection manager 422 can request an MKS (Mouse Keyboard Screen) redirection component 424 on desktop B 420 to communicate with other connected remote desktops (e.g., with desktop A 410) to redirect an app (e.g., the topmost app window on desktop B 420) to the current remote desktop (e.g., the desktop currently being used by the user).

In various embodiments, the app redirection manager 422 on desktop B 420 can work with a corresponding app redirection manager on a target desktop, e.g., with the app redirection manager 412 on desktop A 410, to coordinate app redirection (MKS redirection), file redirection, and clipboard redirection between the desktops.

For example, when a topmost app is redirected from desktop B 410 to desktop A 410, the app redirection manager 412 in desktop A 410 can continuously monitor the window of the redirected app (e.g., a seamless window). If the user closes the window of the redirected app while working in desktop A 410, the app redirection manager 412 can be notified of this event (or detect the event) and the app redirection manager 412 can then coordinate with the app redirection manager 422 on desktop B 420 to redirect the new topmost app (the previous topmost app would be closed on desktop B 420), if there is a new topmost app on desktop B 420.

In various embodiments, when the user switches from one desktop to another remote desktop, for example from desktop A 410 to desktop B 420, the app redirection manager 422 on desktop B 420 can work with the app redirection manager 412 on desktop A 410 to update the information of any apps now being redirected to desktop B 420 from desktop A 410.

When the user disconnects from a remote desktop (e.g., from remote desktop A 410), the app redirection manager 412 can be notified by the client 400 that the desktop session is being terminated or that the desktop is being disconnected and, in response, the app redirection manager 412 can end or terminate all connections between desktop A 410 and other remote desktops (e.g., desktop B 420).

The virtual desktops can contain MKS (Mouse, Keyboard, Screen) redirection modules 414, 424, which can coordinate the redirection of inputs and screen data for redirecting apps between the desktops 410, 420. For example, the MKS redirection modules 414, 424 can communicate with each other and exchange data so that a user who is working on a current remote desktop (e.g., desktop A 410) can see the redirected app (e.g., app redirected from desktop B 420) and operate it using a mouse and a keyboard while working in desktop A 410. For example, the MKS redirection module 424 on the source remote desktop B 420 can capture the desktop B GUI, crop the graphical data of the desktop B GUI leaving the interface of the app and transfer the graphical data of the redirected app window to the MKS redirection module 414 in desktop A 410, so that while working in desktop A the user can see the app window instead of entire GUI of remote desktop B 420. Inputs (e.g., mouse or keyboard) into the redirected app made by the user working in desktop A 410 can be redirected by the MKS redirection module 414 in desktop A to the MKS redirection module 424 in desktop B to be effectuated in the redirected app running in desktop B 420.

In various embodiments, the desktops 410, 420 can contain corresponding clipboard redirection modules 416, 426, which can perform the transferring of clipboard data between the remote desktops 410, 420 so that the user can copy/paste content between the desktops as described previously (e.g., between a redirected app and an app in the desktop to which the app is redirected).

In various embodiments, the desktops 410, 420 can contain corresponding file redirection modules 418, 428, which can correspond with each other to redirect files between the desktops 410, 420, as described previously. For example, when the user connects to multiple desktops (e.g., to desktops A 410 and B 420), the user's files (e.g., the “My Documents” folder) on each remote desktop can be redirected (or mapped) to each other connected remote desktop by the file redirection modules 418, 428 operating on each desktop, so that either connected desktop can access files on the other connected desktop.

Similarly, if an app (e.g., a seamless app) is being redirected from one desktop (e.g., desktop B 420) to another desktop (e.g., desktop A 410), the file redirection modules 418, 428 can correspond with each other to exchange data so that the redirected app can access and open files on either remote desktop 410, 420. For example, if the user drags-and-drops a file located on remote desktop A 410 to a window of an app (e.g., a seamless app) redirected to desktop A 410 from desktop B 420, the file can be redirected to desktop B by the file redirection modules 418, 428 so that the redirected app running in desktop B 420 can access and open it.

Generally, in virtual desktop infrastructure, virtual channels (e.g., protocol virtual channels) are implemented for data transfer between a client device and remote desktops. As illustrated, the client 400 in the client device can contain a virtual channel module 404 that can manage communications over a virtual channel established with corresponding virtual channel modules 419, 429 in virtual desktops A and B, respectively. In various embodiments, virtual channel modules 419, 429 in virtual desktops A and B can contain additional functionality allowing the virtual channel module 419 in desktop A 410 to establish a virtual channel with the virtual channel module 429 in desktop B 420 for transferring data between the desktops for enabling the features discussed herein unifying the desktops, such as mouse, keyboard, and screen redirection in app redirection, file and folder redirection, and clipboard redirection. For example, the virtual channel established between the virtual channel modules 419, 429 can be used by the MKS redirection modules 414, 424, the clipboard redirection modules 416, 426, and the file redirection modules 418, 428 to communicate with each other.

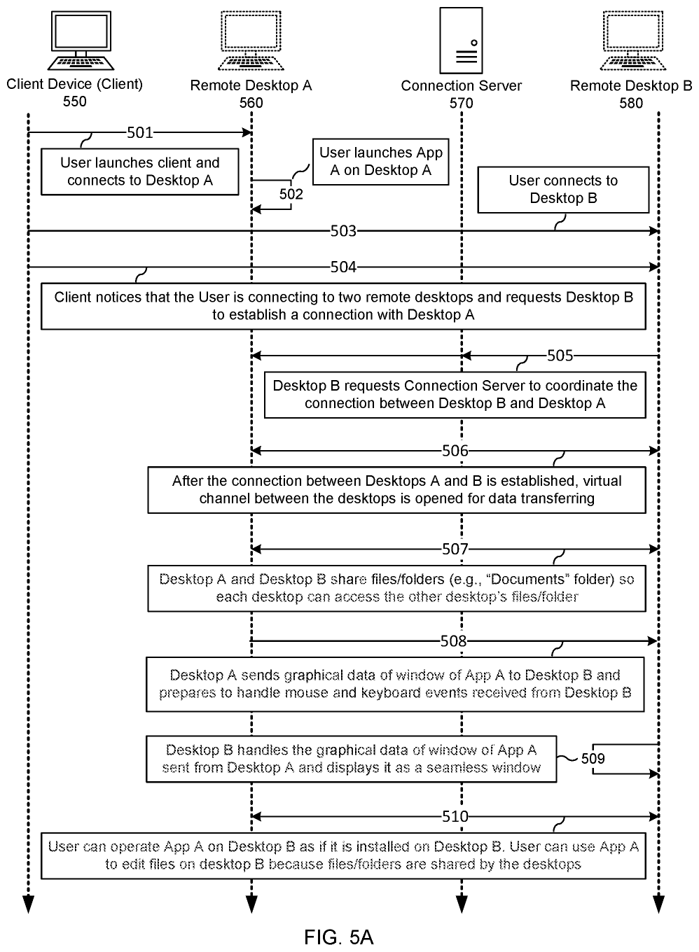

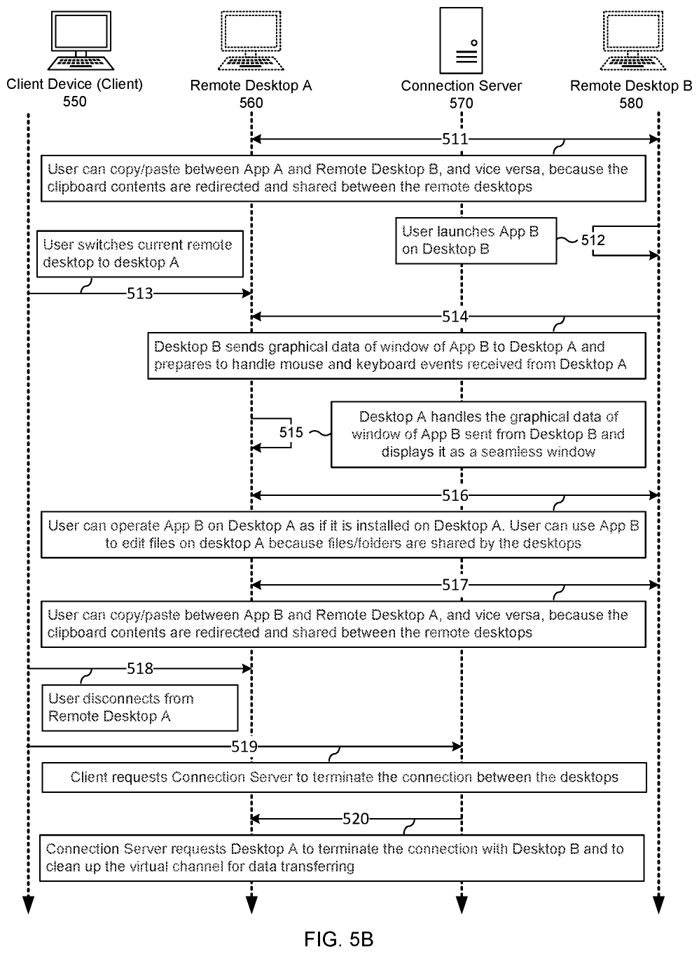

FIG. 5A illustrates part 1 of an example swim lane diagram of a process for unifying and connecting multiple virtual desktops, in accordance with various embodiments. The process can begin in operation 501, where the user can launch a client (e.g., a virtual desktop client) on a client device 550 and connect the client to remote desktop A 560. In operation 502, the user can launch an application, app A, on desktop A. In operation 503, the user can connect the client to remote desktop B 580. Subsequently, in operation 504, the client can notice that the user is connecting to the two remote desktops and request desktop B to establish a connection with desktop A. In response to the request, in operation 505, desktop B can send a request to a connection server 570 to coordinate the connection between desktop B and desktop A, and the connection server can coordinate such a connection. In operation 506, after the connection between desktops A and B is established, a virtual channel between the desktops can be opened for data transferring.

Using the connection and virtual channel for transferring data between the desktops, in operation 507, desktop A and desktop B can share files/folders (e.g., “Documents” folder) so each desktop can access the other desktop's files/folder. For example, certain files, folders, drives, etc. can be redirected from each desktop to the other desktop and presented in a virtual drive, as discussed previously. In operation 508, desktop A can send (over the connection between the desktops) graphical data of the window of app A to desktop B and prepare to handle mouse and keyboard events targeting app A received (over the connection between the desktops) from desktop B. In operation 509, desktop B can handle the graphical data (e.g., receive, decode, and process the graphical data for being displayed) of the window of app A sent from desktop A and display it as a seamless window in the desktop B GUI. In operation 510, the user can operate app A on desktop B as if it is installed on desktop B, and the user can use app A to edit files on desktop B because the files/folders are shared by (or redirected between) the desktops. The process then continues in FIG. 5B.

FIG. 5B illustrates part 2 of an example swim lane diagram of a process for unifying and connecting multiple virtual desktops, in accordance with various embodiments. Continuing from FIG. 5A, in operation 511, the user can copy/paste data between app A and desktop B, and vice versa, because the clipboard contents are redirected and shared between the remote desktops. In operation 512, the user can launch an application, app B, on desktop B. Then, in operation 513, the user can switch the current remote desktop to desktop A (e.g., the user can switch to desktop A to make desktop A the current active desktop).

After the user switches to desktop A, in operation 514, desktop B can send (over the connection between the desktops) graphical data of the window of app B to desktop A and prepare to handle mouse and keyboard events targeting app B received (over the connection between the desktops) from desktop A. In operation 515, desktop A can handle the graphical data (e.g., receive, decode, and process the graphical data for being displayed) of the window of app B sent from desktop B and display it as a seamless window in the desktop A GUI. In operation 516, the user can operate app B on desktop A as if it is installed on desktop A, and the user can use app B to edit files on desktop A because the files/folders are shared by (or redirected between) the desktops. In operation 517, the user can copy/paste data between app B and desktop A, and vice versa, because the clipboard contents are redirected and shared between the remote desktops.

In operation 518, the user can disconnect from desktop A. In response, in operation 519, the client can request the connection server to terminate the connection for transferring data between the desktops. In operation 520, the connection server can request desktop A to terminate the connection with desktop B and to clean up the virtual channel for data transferring.

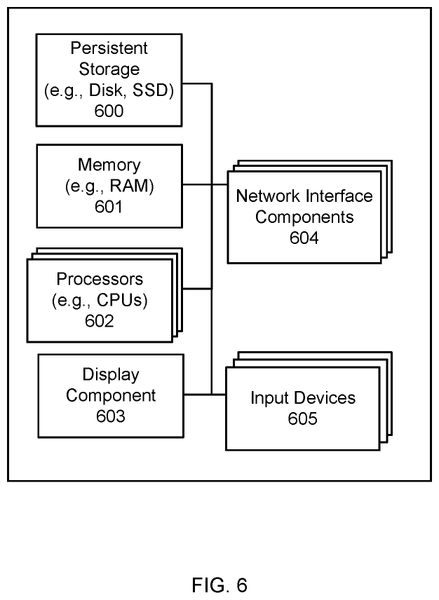

FIG. 6 illustrates an example of some general components of a computing device, in accordance with various embodiments. In this particular example, the device includes one or more processors (e.g., central processing units (CPUs) 602 for executing instructions that can be stored in a storage medium component. The storage medium can include many types of memory, persistent data storage, or non-transitory computer-readable storage media. For example, the storage medium may take the form of random access memory (RAM) 601 storing program instructions for execution by the processor(s) 602, a persistent storage (e.g., disk or SSD) 600, a removable memory for sharing information with other devices and/or the like. The computing device typically can further comprise a display component 603, such as a monitor, a touch screen, liquid crystal display (LCD), or the like. In various embodiments, the computing device will include at least one input device 605 able to receive conventional input from a user. This conventional input can include, for example, a push button, touch pad, touch screen, wheel, joystick, keyboard, mouse, keypad, or any other such device or element whereby a user can input a command to the device. In some embodiments, the computing device can include a network interface component (NIC) 604 for communicating over various networks, such as a Wi-Fi®, Bluetooth®, RF, wired, or wireless communication systems. The device in many embodiments can communicate over a network, such as the Internet, and may be able to communicate with other devices connected to the same or other network.

Various embodiments described herein can be implemented in a wide variety of environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Many embodiments utilize at least one network that would be familiar to those skilled in the art for supporting communications using any of a variety of commercially-available protocols, such as TCP/IP, FTP, UDP or the like. The network can be, for example, a local area network, a wide-area network, a virtual private network, the Internet, an intranet, an extranet, a public switched telephone network, an infrared network, a wireless network, and any combination thereof.

The various environments in which the embodiments can be implemented may include a variety of data stores and other memory and storage media, as discussed above. These can reside in a variety of locations, such as on a storage medium local to one or more of the computers or remote from any or all of the computers across the network. In some embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method, comprising:
by a virtual desktop client operating on a client device, establishing a first virtual desktop session on a first virtual desktop and, by the virtual desktop client, establishing a second virtual desktop session on a second virtual desktop, the first virtual desktop and the second virtual desktop executing on one or more host servers;
establishing a connection between the first virtual desktop and the second virtual desktop for exchanging data between the first virtual desktop and the second virtual desktop; and
using the connection between the first virtual desktop and the second virtual desktop, performing at least one of:
redirecting an application executing in the first virtual desktop to the second virtual desktop to enable a user of the client device to access and interact with the redirected application from within the second virtual desktop;
redirecting a clipboard from the first virtual desktop to the second virtual desktop to enable the user to copy data from the first virtual desktop and paste it into the second virtual desktop; or
redirecting a file from the first virtual desktop to the second virtual desktop to enable applications running in the second virtual desktop to access the file located on the first virtual desktop.

2. The method of claim 1, further comprising:
detecting by the virtual desktop client that multiple virtual desktop sessions including the first virtual desktop session and the second virtual desktop session are established and, in response to detecting that the multiple virtual desktop sessions are established, requesting one of the virtual desktops to establish the connection with the other virtual desktop.

3. The method of claim 1, further comprising:
redirecting a topmost application of the first virtual desktop to the second virtual desktop when the user switches to the second virtual desktop or redirecting a topmost application of the second virtual desktop to the first virtual desktop when the user switches to the first virtual desktop.

4. The method of claim 1, wherein redirecting the application executing in the first virtual desktop to the second virtual desktop comprises:
streaming graphical data of the application from the first virtual desktop to the second virtual desktop over the established connection between the desktops; and
sending user mouse and keyboard inputs targeting the application from the second virtual desktop to the first virtual desktop to be effectuated in the application.

5. The method of claim 1, further comprising:
redirecting the application executing in the first virtual desktop to the second virtual desktop to enable the user of the client device to access and interact with the redirected application from within the second virtual desktop;
receiving a user request in the second virtual desktop to copy data from the redirected application and receiving a subsequent user request in the second virtual desktop to paste the data into an application executing in the second virtual desktop; and
transferring the data from the first virtual desktop to the second virtual desktop over the established connection between the first virtual desktop and the second virtual desktop to perform the paste request.

6. The method of claim 1, wherein redirecting the file from the first virtual desktop to the second virtual desktop comprises presenting a virtual drive mounted in the second virtual desktop that is mapped to the first virtual desktop.

7. The method of claim 1, wherein the application is redirected from the first virtual desktop to the second virtual desktop as a seamless window.

8. A computing device, comprising:
at least one processor; and
memory including instructions that, when executed by the at least one processor, cause the computing device to perform the steps of:
by a virtual desktop client operating on a client device, establishing a first virtual desktop session on a first virtual desktop and, by the virtual desktop client, establishing a second virtual desktop session on a second virtual desktop, the first virtual desktop and the second virtual desktop executing on one or more host servers;
establishing a connection between the first virtual desktop and the second virtual desktop for exchanging data between the first virtual desktop and the second virtual desktop; and
using the connection between the first virtual desktop and the second virtual desktop, performing at least one of:
redirecting an application executing in the first virtual desktop to the second virtual desktop to enable a user of the client device to access and interact with the redirected application from within the second virtual desktop;
redirecting a clipboard from the first virtual desktop to the second virtual desktop to enable the user to copy data from the first virtual desktop and paste it into the second virtual desktop; or
redirecting a file from the first virtual desktop to the second virtual desktop to enable applications running in the second virtual desktop to access the file located on the first virtual desktop.

9. The computing device of claim 8, wherein the memory further includes instructions that when executed by the at least one processor, cause the computing device to perform the steps of:
detecting by the virtual desktop client that multiple virtual desktop sessions including the first virtual desktop session and the second virtual desktop session are established and, in response to detecting that the multiple virtual desktop sessions are established, requesting one of the virtual desktops to establish the connection with the other virtual desktop.

10. The computing device of claim 8, wherein the memory further includes instructions that when executed by the at least one processor, cause the computing device to perform the steps of:
redirecting a topmost application of the first virtual desktop to the second virtual desktop when the user switches to the second virtual desktop or redirecting a topmost application of the second virtual desktop to the first virtual desktop when the user switches to the first virtual desktop.

11. The computing device of claim 8, wherein redirecting the application executing in the first virtual desktop to the second virtual desktop comprises:
streaming graphical data of the application from the first virtual desktop to the second virtual desktop over the established connection between the desktops; and
sending user mouse and keyboard inputs targeting the application from the second virtual desktop to the first virtual desktop to be effectuated in the application.

12. The computing device of claim 8, wherein the memory further includes instructions that when executed by the at least one processor, cause the computing device to perform the steps of:
redirecting the application executing in the first virtual desktop to the second virtual desktop to enable the user of the client device to access and interact with the redirected application from within the second virtual desktop;
receiving a user request in the second virtual desktop to copy data from the redirected application and receiving a subsequent user request in the second virtual desktop to paste the data into an application executing in the second virtual desktop; and
transferring the data from the first virtual desktop to the second virtual desktop over the established connection between the first virtual desktop and the second virtual desktop to perform the paste request.

13. The computing device of claim 8, wherein redirecting the file from the first virtual desktop to the second virtual desktop comprises presenting a virtual drive mounted in the second virtual desktop that is mapped to the first virtual desktop.

14. The computing device of claim 8, wherein the application is redirected from the first virtual desktop to the second virtual desktop as a seamless window.

15. A non-transitory computer readable storage medium comprising one or more sequences of instructions, the instructions when executed by one or more processors causing the one or more processors to execute the operations of:
by a virtual desktop client operating on a client device, establishing a first virtual desktop session on a first virtual desktop and, by the virtual desktop client, establishing a second virtual desktop session on a second virtual desktop, the first virtual desktop and the second virtual desktop executing on one or more host servers;
establishing a connection between the first virtual desktop and the second virtual desktop for exchanging data between the first virtual desktop and the second virtual desktop; and
using the connection between the first virtual desktop and the second virtual desktop, performing at least one of:
redirecting an application executing in the first virtual desktop to the second virtual desktop to enable a user of the client device to access and interact with the redirected application from within the second virtual desktop;
redirecting a clipboard from the first virtual desktop to the second virtual desktop to enable the user to copy data from the first virtual desktop and paste it into the second virtual desktop; or
redirecting a file from the first virtual desktop to the second virtual desktop to enable applications running in the second virtual desktop to access the file located on the first virtual desktop.

16. The non-transitory computer readable storage medium of claim 15, further comprising instructions that when executed by the one or more processors cause the one or more processors to execute the operations of:
detecting by the virtual desktop client that multiple virtual desktop sessions including the first virtual desktop session and the second virtual desktop session are established and, in response to detecting that the multiple virtual desktop sessions are established, requesting one of the virtual desktops to establish the connection with the other virtual desktop.

17. The non-transitory computer readable storage medium of claim 15, further comprising instructions that when executed by the one or more processors cause the one or more processors to execute the operations of:
redirecting a topmost application of the first virtual desktop to the second virtual desktop when the user switches to the second virtual desktop or redirecting a topmost application of the second virtual desktop to the first virtual desktop when the user switches to the first virtual desktop.

18. The non-transitory computer readable storage medium of claim 15, wherein redirecting the application executing in the first virtual desktop to the second virtual desktop comprises:
streaming graphical data of the application from the first virtual desktop to the second virtual desktop over the established connection between the desktops; and
sending user mouse and keyboard inputs targeting the application from the second virtual desktop to the first virtual desktop to be effectuated in the application.

19. The non-transitory computer readable storage medium of claim 15, further comprising instructions that when executed by the one or more processors cause the one or more processors to execute the operations of:
redirecting the application executing in the first virtual desktop to the second virtual desktop to enable the user of the client device to access and interact with the redirected application from within the second virtual desktop;
receiving a user request in the second virtual desktop to copy data from the redirected application and receiving a subsequent user request in the second virtual desktop to paste the data into an application executing in the second virtual desktop; and
transferring the data from the first virtual desktop to the second virtual desktop over the established connection between the first virtual desktop and the second virtual desktop to perform the paste request.

20. The non-transitory computer readable storage medium of claim 15, wherein redirecting the file from the first virtual desktop to the second virtual desktop comprises presenting a virtual drive mounted in the second virtual desktop that is mapped to the first virtual desktop.
